(19) United States
(12) Patent Application Publication
(10) Pub. No.: US 2026/0092741 A1
(43) Pub. Date: Apr. 2, 2026

(54) REFLOW OVEN

(71) Applicant: Illinois Tool Works Inc., Glenview, IL (US)

(72) Inventors: Weizhou LIU, Suzhou New District (CN); Zhaoping HU, Suzhou New District (CN); Chuanbo WANG, Suzhou New District (CN)

(21) Appl. No.: 19/110,498

(22) PCT Filed: Aug. 14, 2023
(86) PCT No.: PCT/US2023/072165

§ 371 Date: Mar. 11, 2025

(30) Foreign Application Priority Data
Sep. 29, 2022 (CN) 202211198636.2

(51) Int. Cl. F27D 7/04; F16L 9/22; F16L 59/14; F27B 9/30

(52) U.S. Cl. CPC F27D 7/04; F16L 9/22; F16L 59/14; F27B 9/3005

(57) ABSTRACT

The present application provides a reflow oven (100). The reflow oven (100) comprises a furnace (101) and a gas pipeline assembly (104, 106). The furnace (101) comprises a plurality of furnace chambers Li (i=1, 2, . . . , n). The gas pipeline assembly (104, 106) comprises a plurality of gas sub-pipelines (104.i, 106.i) (i=1, 2, . . . , n). The plurality of gas sub-pipelines (104.i, 106.i) are detachably connected in a series to form a gas passage. At least a portion of the plurality of gas sub-pipelines (104.i. 106.i) is connected to at least a portion of the plurality of furnace chambers Li such that the plurality of furnace chambers Li is connected to the gas passage.

### RELATED APPLICATIONS

This international application claims priority to Chinese Patent Application No. 202211198636.2, filed Sep. 29, 2022, entitled “Reflow Oven.” The entirety of Chinese Patent Application No. 202211198636.2 is incorporated herein by reference.

### TECHNICAL FIELD

The present application relates to a reflow oven, particularly to the disposition of a gas pipeline of a reflow oven.

### BACKGROUND

In the manufacturing of printed circuit boards, electronic elements are typically mounted to a circuit board using a reflow soldering process. In a typical reflow soldering process, a solder paste is deposited into a selected area on a circuit board and a wire of one or more electronic elements is inserted into the deposited solder paste. The circuit board then passes through a reflow oven in which the solder paste reflows (i.e., is heated to a melting or reflow temperature) in a heating area and then cools in a cooling area to form solder joints electrically and mechanically connecting the wires of the electronic elements to the circuit board. During the reflow soldering process, it is necessary to convey the soldering protective gas (e.g., air or nitrogen) into the furnace of the reflow oven to create an anti-oxidation protective atmosphere to prevent oxidation of the circuit board, so as to improve the soldering quality. After the soldering protective gas enters the furnace of the reflow oven, a soldering flux that is volatile at high temperatures is mixed into the soldering protective gas, and the soldering flux mixed into the soldering protective gas affects soldering quality. Hence, soldering protective gas also needs to be recovered from the furnace of the reflow oven (particularly the heating area).

### SUMMARY

The present application provides a reflow oven, which uses a gas conveying pipeline and a gas discharge pipeline that are detachably connected in a series by a plurality of gas conveying sub-pipelines and gas discharge sub-pipelines, respectively, to facilitate disassembly of the gas conveying pipeline and gas discharge pipeline for cleaning and maintenance.

A reflow oven according to one aspect of the present application comprises a furnace and a gas pipeline assembly. The gas pipeline assembly comprises a plurality of gas sub-pipelines. At least a portion of the plurality of gas sub-pipelines is connected to at least a portion of the plurality of furnace chambers Li such that the plurality of furnace chambers Li is connected to the gas passage.

In the reflow oven as described above, the gas pipeline assembly comprises a gas discharge pipeline. The gas discharge pipeline comprises a plurality of gas discharge sub-pipelines that are detachably connected in a series to form a gas discharge passage, at least a portion of the plurality of gas discharge sub-pipelines being connected to at least a portion of the plurality of furnace chambers Li to recover gas from the plurality of furnace chambers Li.

In the reflow oven as described above, the gas pipeline assembly comprises a gas conveying pipeline. The gas conveying pipeline comprises a plurality of gas conveying sub-pipelines that are detachably connected in a series to form a gas conveying passage, at least a portion of the plurality of gas conveying sub-pipelines being connected to at least a portion of the plurality of furnace chambers Li to convey gas to the plurality of furnace chambers Li.

In the reflow oven as described above, the plurality of gas discharge sub-pipeline and the plurality of gas conveying sub-pipelines comprise at least one retractable tube, respectively.

In the reflow oven as described above, the retractable tube is a corrugated steel tube.

The reflow oven as described above also comprises a plurality of quick-release components, the adjacent plurality of gas discharge sub-pipelines and the adjacent plurality of gas conveying sub-pipelines being detachably connected through the plurality of quick-release components, respectively.

In the reflow oven as described above, the quick-release component is a quick-release clamp, and each quick-release clamp comprises a first clamping portion, a second clamping portion, a support ring, a sealing ring, and a lock member. The first and second clamping portions each have a receiving opening at a respective first end, and the first and second clamping portions are rotatably connected at a respective second end such that the respective first ends of the first and second clamping portions are movable towards or away from one another. When the respective first ends of the first and second clamping portions are connected to one another, the quick-release clamp is in the locked position and forms a clasp, in which a groove extending along the inner surface of the clasp is provided thereon. The support ring has a width that is smaller than the groove of the clasp and when the quick-release clamp is in the locked position, the support ring is positioned on the inner side of the clasp. The width of the sealing ring is between the width of the groove of the clasp and the width of the support ring, and when the quick-release clamp is in the locked position, the sealing ring is positioned between the support ring and the clasp. The lock member may be inserted into and secured in the receiving opening of the first and second clamping portions. When the lock member is inserted into and secured in the receiving openings, the first and second clamping portions are connected together, and when the lock member is removed from the receiving openings, the first and second clamping portions are rotatable such that respective first ends are away from each other to release the connection between the quick-release clamp and the adjacent gas discharge sub-pipelines or adjacent gas conveying sub-pipelines. The plurality of gas discharge sub-pipelines and the plurality of gas conveying sub-pipelines comprise protruding rings disposed at both ends of the plurality of gas discharge sub-pipelines and the plurality of gas conveying sub-pipelines. When the quick-release clamp connects two adjacent gas discharge sub-pipelines in the plurality of gas discharge sub-pipelines or two adjacent gas conveying sub-pipelines in the plurality of gas conveying sub-pipelines, two adjacent protruding rings of the plurality of two adjacent gas discharge sub-pipelines or two adjacent conveying sub-pipelines are received and secured in the groove of the clasp, and the two adjacent protruding rings engage both sides of the sealing ring in the width direction, respectively.

In the reflow oven as described above, the sum of the thickness of the two adjacent protruding rings and the width of the sealing ring is slightly greater than the width of the groove of the clasp such that when the two adjacent protruding rings are received and secured in the groove of the clasp, the two adjacent protruding rings squeeze the sealing ring such that it deforms and seals the connection between the two adjacent gas discharge sub-pipelines or the two adjacent gas conveying sub-pipelines, and the sum of the thickness of the two adjacent protruding rings and the width of the support ring is slightly smaller than the width of the groove of the clasp such that the two adjacent protruding rings are capable of being received by the groove of the clasp.

In the reflow oven as described above, the protruding rings have a step at a position proximate to the bottom such that when the quick-release clamp is in the locked position, the step of the protruding rings is supported on the support ring.

In the reflow oven as described above, the at least a portion of the plurality of gas discharge sub-pipelines is connected to a gas recovery tube and the at least a portion of the plurality of gas conveying sub-pipelines is connected to a gas supply tube. The reflow oven further comprises a plurality of connecting tubes connecting to at least a portion of the plurality of furnace areas Li, in which the gas recovery tube and the gas supply tube are detachably connected by a respective connecting tube on the quick-release clamp and corresponding furnace chambers Li, respectively.

The reflow oven as described above further comprises an insulating sleeve that detachably wraps the outside of the gas pipeline assembly. The insulating sleeve comprises an insulating material, a fibrous material attached to both sides of the insulating material, and a connecting structure. The connecting structure is connected to the fibrous material. When the insulating sleeve wraps the outside of gas pipeline assembly, the connecting structure causes both ends of the insulating sleeve to be detachably connected, so as to wrap the gas pipeline assembly.

In the reflow oven as described above, the insulating material is mineral wool and the connecting structure is a hook-and-loop fastener.

A reflow oven according to another aspect of the present application comprises a heating zone and a gas discharge pipeline. The heating zone comprises a plurality of furnace chambers Li divided into at least two segments, which comprise a furnace chamber segment Q1 and a furnace chamber segment Q2. The gas discharge pipeline comprises a plurality of gas discharge sub-pipelines 106.i detachably connected in a series to at least two gas discharge pipeline segments, which comprise a first gas discharge pipeline segment Z1 and a second gas discharge pipeline segment Z2. A first number of gas discharge sub-pipelines in the plurality of gas discharge sub-pipelines is detachably connected in a series to form the first gas discharge pipeline segment Z1, which is connected to the furnace chamber segment Q1 and recovers gas therefrom. A second number of gas discharge sub-pipelines in the plurality of gas discharge sub-pipelines is detachably connected in a series to form the second gas discharge pipeline segment Z2, which is connected to the furnace chamber segment Q2 and recovers gas therefrom.

In the reflow oven as described above, the plurality of furnace chambers Li is divided into m furnace chamber segments, which comprise the furnace chamber segment Q1, furnace chamber segment Q2, . . . , furnace chamber segment Qm. The plurality of gas discharge sub-pipelines is divided into m segments. The plurality of gas discharge sub-pipelines is detachably connected in a series to form m gas discharge pipeline segments, which comprise the first gas discharge pipeline segment Z1, second gas discharge pipeline segment Z2 . . . , m gas discharge pipeline segment Zm. The m gas discharge pipeline segments are connected to the corresponding m furnace chamber segments, respectively, to recover gas from the m furnace chamber segments, respectively.

In the reflow oven as described above, at least a portion of the m gas discharge pipeline segments comprise at least one retractable tube (106.i).

In the reflow oven as described above, the adjacent plurality of gas discharge sub-pipelines is connected through quick-release clamps.

### BRIEF DESCRIPTION OF THE DRAWINGS

FIG. 1a is a schematic structural diagram of a reflow oven according to an example of the present application;

FIG. 1b is an enlarged view of the partial structure of the gas conveying pipeline and the gas discharge pipeline of the reflow oven in FIG. 1.

FIG. 1c is a stereoscopic view of a gas conveying sub-pipeline.

FIG. 2a is a stereoscopic view of one angle of a quick-release clamp of the present application in the locked state.

FIG. 2b is a stereoscopic view of another angle of a quick-release clamp of the present application in the locked state.

FIG. 2c is a cross-sectional view of a quick-release clamp of the present application in the locked state.

FIG. 3 is a cross-sectional view of a quick-release clamp connected to two adjacent gas conveying sub-pipelines.

FIG. 4a shows a schematic diagram of an alternative disposition for a gas discharge pipeline in a heating zone of a reflow oven according to the present application.

FIG. 4b is an enlarged view of the partial structure of the gas conveying pipeline and the gas discharge pipeline of the example of the reflow oven in FIG. 4a.

FIG. 5 is a schematic diagram of another alternative disposition for a gas discharge pipeline in a heating zone of a reflow oven according to the present application.

FIG. 6a is an enlarged view of the partial structure of a gas conveying pipeline wrapped with an insulating sleeve according to the present application.

FIG. 6b is a schematic cross-sectional view of the insulating sleeve of FIG. 6a in the expanded state.

### DETAILED DESCRIPTION

Various specific embodiments of the present application will be described below with reference to the attached drawings that form a part of the present specification. It should be understood that the same or similar reference numerals used in the present application refer to the same components where possible.

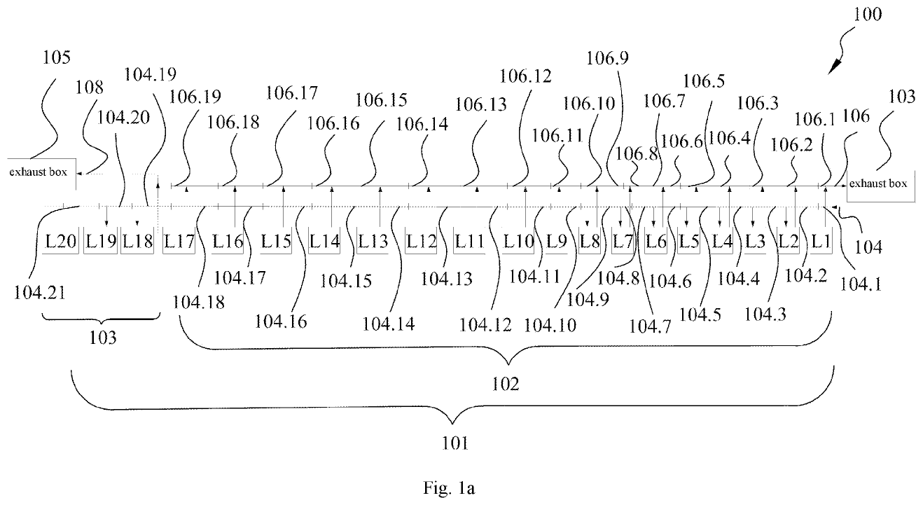

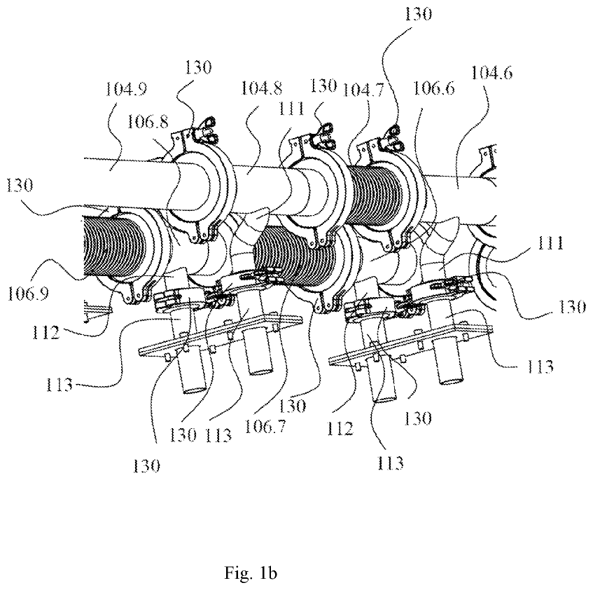

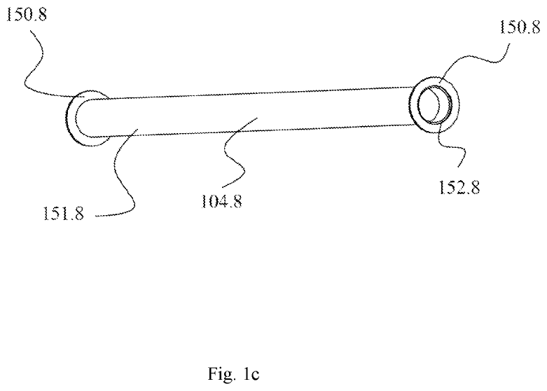

FIG. 1a is a schematic structural diagram of a reflow oven 100 according to an example of the present application. As shown in FIG. 1a, the reflow oven 100 comprises a furnace 101 and 20 furnace chambers L1-L20 disposed therein. Among the 20 furnace chambers shown in FIG. 1a, L1-L17 constitutes the heating zone 102 and L18-L20 constitutes the cooling zone 103. Although the reflow oven 100 shown in FIG. 1 a comprises 20 furnace chambers, in other examples, the reflow oven may comprise a different number of furnace chambers, where the number of furnace chambers include, but is not limited to, 12 or 14. The reflow oven 100 also comprises a gas conveying pipeline 104, a gas discharge pipeline 106, and a gas discharge pipeline 108. The reflow oven 100 shown in FIG. 1a uses air as a soldering protective gas, the gas conveying pipeline 104 is used to convey air to the furnace 101, the gas discharge pipeline 106 is used to recover air from the heating zone 102 of the furnace 101 to an exhaust box 103, and the gas discharge pipeline 108 is used to recover air between the heating zone 102 and the cooling zone 103 to an exhaust box 105. In other examples, other gases (e.g., nitrogen) may be used as the soldering protective gas. It should be understood that in examples where nitrogen is used as the soldering protective gas, nitrogen may be conveyed to different numbers of furnace chambers and recovered from different numbers of furnace chambers. Moreover, nitrogen recovered into the gas discharge pipeline 106 is re-conveyed to the corresponding furnace chamber after being purified.

The gas conveying pipeline 104 comprises a plurality of gas conveying sub-pipelines 104.i (i=1, 2, . . . , n) and the gas discharge pipeline 106 comprises a plurality of gas discharge sub-pipelines 106.i (i=1, 2, . . . n). FIG. 1a shows 21 gas conveying sub-pipelines 104.i and 19 gas discharge sub-pipelines 106.i. It should be understood that other examples may have different numbers of gas conveying sub-pipelines 104.i and gas discharge sub-pipelines 106.i. The gas conveying sub-pipelines 104.1-104.21 may be detachably connected in a series to form a gas conveying passage, and a portion of the gas conveying sub-pipelines 104.1-104.21 is connected to at least a portion of the furnace chambers L1-L20 to convey air to the furnace chambers L1-L20. The gas discharge sub-pipelines 106.1-106.19 may be detachably connected in a series to form a gas discharge passage, and at least a portion of the gas discharge sub-pipelines 106.1-106.19 is connected to at least a portion of the furnace chambers L1-L17 to discharge air from the furnace chambers L1-L17. In the example shown in FIG. 1a, the gas conveying sub-pipelines 104.2-104.9 and 104.19-104.20 convey air to the furnace chambers L2-L8 and L18-L19, respectively, and the gas discharge pipelines 106.1-106.6, 106.8 and 106.10-106.19 recover air from the furnace chambers L1-L17, respectively. In other examples, air may be conveyed by other gas conveying sub-pipelines or different numbers of gas conveying sub-pipelines to other furnace chambers or different numbers of furnace chambers, and may be recovered by other gas discharge sub-pipelines or different numbers of gas discharge pipelines from other furnace chambers or different numbers of furnace chambers.

FIG. 1b is an enlarged view of the partial structure of the gas conveying pipeline 104 and the gas discharge pipeline 106 of the reflow oven 100 in FIG. 1a. FIG. 1b shows a portion of the gas conveying sub-pipelines 104.6-104.9 and a portion of the gas discharge sub-pipelines 106.6-106.9. FIG. 1b shows that adjacent gas conveying sub-pipelines 104.6-104.9 and adjacent gas discharge sub-pipelines 106.6-106.9 are detachably connected by a quick-release component, respectively. As shown in FIG. 1b, the gas conveying sub-pipelines 104.6 and 104.8 are connected to a gas supply tube 111, respectively, and the gas supply tube 111 is connected to a connecting tube 113 disposed on the corresponding furnace chambers Li (not shown in FIG. 1b) by a quick-release component to convey air to the furnace chambers Li. Similarly, the gas discharge sub-pipelines 106.6 and 106.8 are connected to a gas recovery tube 112, respectively, and the gas recovery tube 112 is connected to the connecting tube 113 disposed on the corresponding furnace chambers Li (not shown in FIG. 1b) by a quick-release component to recover air from the furnace chambers Li. In the example shown in FIG. 1b, the quick-release components that connect adjacent gas conveying sub-pipelines, connect adjacent gas discharge sub-pipelines, and connect the gas supply tube 111 or gas recovery tube 112 to the connecting tube 113 are quick-release clamps 130. It should be understood that such a connection may be achieved using other quick-release components in other examples. Among the gas conveying sub-pipelines 104.6-104.9 shown in FIG. 1b, the gas conveying sub-pipelines 104.6, 104.8, and 104.9 are non-retractable tubes, while the gas conveying sub-pipeline 104.7 is a retractable tube. Similarly, in the gas discharge sub-pipelines 106.6-106.9, the gas discharge sub-pipelines 106.6 and 106.8 are non-retractable tubes, while the gas discharge sub-pipelines 106.7 and 106.9 are retractable tubes. The retractable tubes 104.7, 106.7, and 106.9 are adjustable in length. In the example shown in FIG. 1b, the non-retractable tubes 104.6, 104.8, 104.9, 106.6, and 106.8 are straight steel tubes, and the retractable tubes 104.7, 106.7, and 106.9 are corrugated steel tubes. It should be understood that in other examples, the retractable tube may have other structures. The gas conveying pipeline 104 and the gas discharge pipeline 106 comprise at least one retractable gas conveying sub-pipeline or a retractable gas discharge sub-pipeline such that the length of the gas conveying pipeline 104 and the gas discharge pipeline 106 is adjustable. In an example, the gas conveying sub-pipeline 104.i and the gas discharge sub-pipeline 106.i connected to the connecting tube 113 of any two furnace chambers comprise at least one retractable tube such that the length of pipeline composed of one or more gas conveying sub-pipelines 104.i and one or more gas discharge sub-pipelines 106.i that are connected to any two connecting tubes 113 is adjustable.

FIG. 1c shows a stereoscopic view of the gas conveying sub-pipeline 104.8. As shown in FIG. 1c, the gas conveying sub-pipeline 104.8 comprises a main body 151.8 and protruding rings 150.8 disposed on both ends of the main body 151.8. The protruding rings 150.8 have a certain thickness in the direction parallel to the main body 151.8. The protruding rings 150.8 have a step 152.8 that extends along the inner perimeter thereof at a bottom thereof that is proximate to the main body 151.8. Although FIG. 1 only shows the protruding ring structure of the gas conveying sub-pipeline 104.8, it should be understood that other gas conveying sub-pipelines 104.i have similar protruding rings 150.i and steps 152.i thereon. As will be discussed below, the disposition of the protruding rings 150.i and the steps 152.i thereon allows adjacent gas conveying sub-pipelines 104.i to be connected by a quick-release clamp 130. Similarly, the gas discharge sub-pipelines 106.i, gas supply tube 111, gas recovery tube 112, and connecting tube 113 also have similar protruding ring structures.

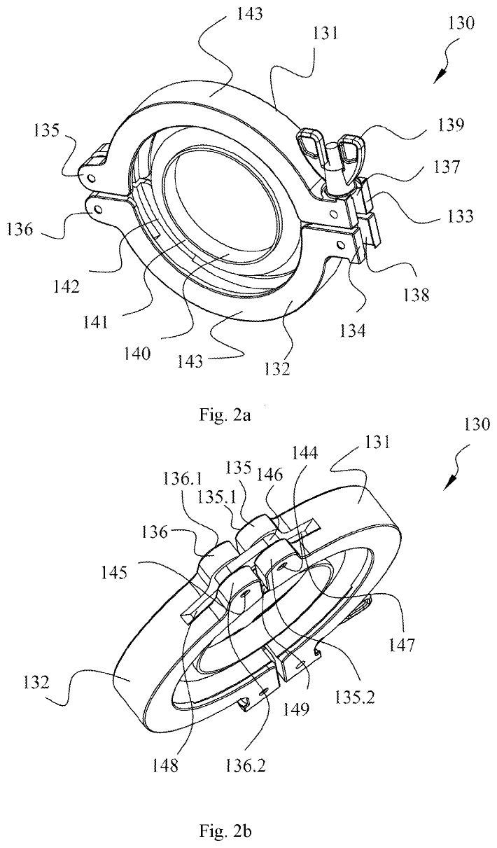

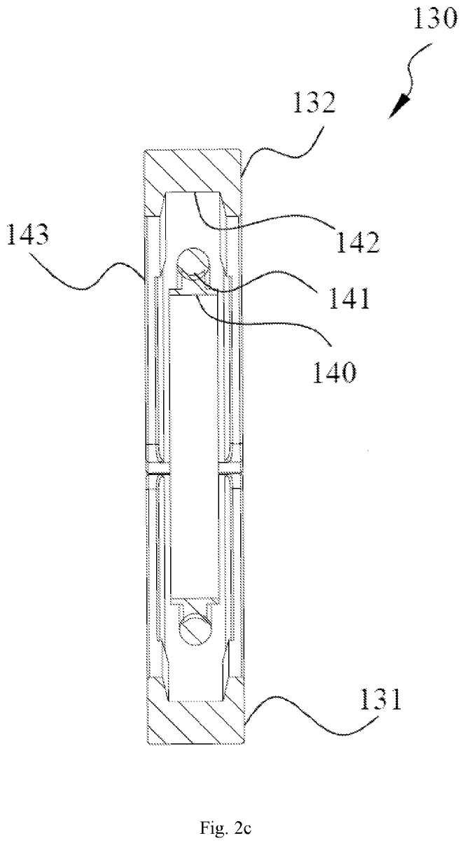

FIGS. 2a-2c show the quick-release clamp 130 in FIG. 1b, in which FIGS. 2a and 2b show a stereoscopic view of the quick-release clamp 130 at different angles in the locked position and FIG. 2c is a cross-sectional view of the quick-release clamp 130 in the locked position. The structure of the quick-release clamp 130 is described in conjunction with FIGS. 2a-2c. As shown in FIGS. 2a-2c, the quick-release clamp 130 comprises a first clamping portion 131 and a second clamping portion 132. The first clamping portion 131 is provided with a receiving opening 137 at a first end 133 thereof and the second clamping portion 132 is provided with a receiving opening 138 at a first end 134 thereof. When the quick-release clamp 130 is in the locked position, a lock member 139 is inserted into and locked in the receiving openings 137 and 138 to connect the first and second clamping portions 131, 132. In the example of the quick-release clamp 130 shown in FIGS. 2a-2c of the present application, the lock member 139 consists of a bolt and a wingnut. When the quick-release clamp 130 is in the locked position, the first and second clamping portions 131, 132 are connected to form a clasp 143. A groove 142 extending along the inner surface of the clasp 143 is provided thereon.

The first clamping portion 131 is provided with a notch 147 at a second end 135 thereof, the notch 147 dividing the second end 135 of the first clamping portion 131 into a first portion 135.1 and a second portion 135.2, which are provided with an aligned hole 144 thereon (the hole 144 on the first portion 135.1 is not shown in FIG. 2B). The second clamping portion 132 is provided with a notch 148 at a second end 136 thereof, the notch 148 dividing the second end 136 of the second clamping portion 132 into a first portion 136.1 and a second portion 136.2, which are provided with an aligned hole 145 thereon (the hole 145 on the first portion 136.1 is not shown in FIG. 2B). A gasket 146 is received in the notches 147 and 148, and two holes (not shown in FIG. 2b) are provided on a gasket 147, and aligned with the holes 144 and 145, respectively. A shaft (not shown in FIG. 2b) is inserted into and secured in the hole 144 on the first portion 135.1 and second portion 135.2 of the second end 135 of the first clamping portion 131, and one hole on the gasket 147 such that the first clamping portion 131 is capable of rotating around the shaft. Another shaft (not shown in FIG. 2b) is inserted into the hole 145 on the first portion 136.1 and second portion 136.2 of the second end 136 of the second clamping portion 132 and another hole on the gasket 147 such that the second clamping portion 132 is capable of rotating around the shaft. There is a gap 149 between the second end 135 of the first clamping portion 131 and the second end 136 of the second clamping portion 132, and the gap 149 provides space for the rotation of the first and second clamping portions 131, 132. When the first and second clamping portions 131, 132 rotate around the shaft disposed at the respective second ends 135 and 136 towards each other, the first end 133 of the first clamping portion 131 and first end 134 of the second clamping portion 132 move towards each other and when the first and second clamping portions 131, 132 rotate into place, the lock member 139 is inserted into and secured in the receiving openings 137, 138 at the first end 133 of the first clamping portion 131 and the second end 134 of the second clamping portion 132 to connect the first end 133 of the first clamping portion 131 and second end 134 of the second clamping portion 132. At this point, the quick release clamp 130 is in the locked position. When the quick-release clamp 130 is in the locked position, the first and second clamping portions 131, 132 are connected to form a clasp 143. When the lock member 139 is removed from the receiving openings 137 and 138, the first and second clamping portions 131, 132 are able to rotate around the shaft disposed at the respective second ends 135 and 136 away from each other such that the respective first ends 133 and 134 of the first and second clamping portions 131 and 132 move away from each other to separate. At this point, the quick-release clamp 130 is in the open position.

Continuing to refer to FIGS. 2a-2c, the quick-release clamp 130 further comprises a support ring 140 and a sealing ring 141. When the quick-release clamp 130 is in the locked position, the support ring 140 is located on the inner side of the clasp 143 and the sealing ring 141 is supported on the support ring 140 between the support ring 140 and the clasp 143. The width of the support ring 140 is less than the width of the groove 142 of the clasp 143. The width of the sealing ring 141 is between the width of the support ring 140 and the width of the groove 142 of the clasp 143. “Width” herein refers to the dimension parallel to the length direction of the gas conveying sub-pipelines 104.i or the gas discharge sub-pipelines 106.i when the quick-release clamp 130 is connected to the gas conveying sub-pipelines 104.i or the gas discharge sub-pipelines 106.i. As shown in FIG. 2c, the outer diameter of the support ring 140 and the sealing ring 141 is smaller than the inner diameter of the clasp 143 such that the support ring 140 and the sealing ring 141 are separated from the clasp 143. As will be discussed below, the support ring 140 and sealing ring 141 are clamped and secured by two adjacent gas conveying sub-pipelines or gas discharge sub-pipelines.

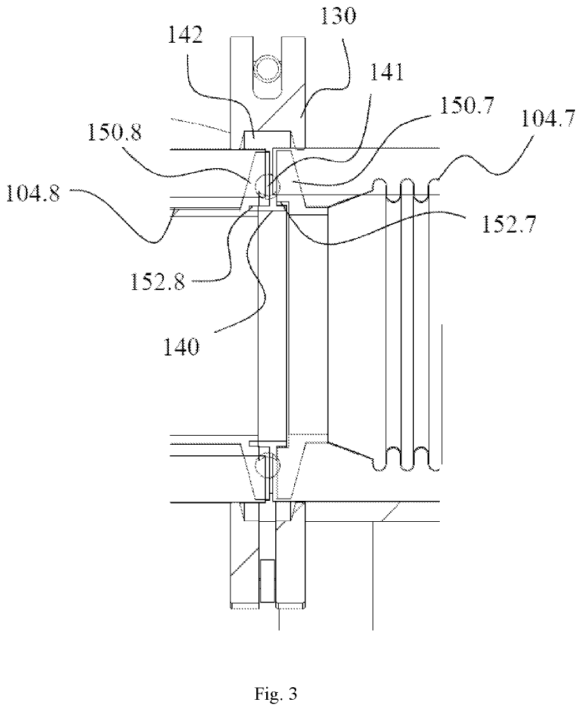

FIG. 3 shows a cross-sectional view of the quick-release clamp 130 connecting two adjacent gas conveying sub-pipelines 104.7 and 104.8. As shown in FIG. 3, when the quick-release clamp 130 connects the gas conveying sub-pipelines 104.7 and 104.8, the protruding ring 150.7 of the gas conveying sub-pipeline 104.7 and the protruding ring 150.8 of the gas conveying sub-pipeline 104.8 engage both sides of the sealing ring 141 in the width direction, respectively, and clamp the sealing ring 141 and the support ring 140 supported by the sealing ring 141 between the protruding rings 150.7 and 150.8, which are received in the groove 142 of the clasp 143. The sum of the thickness of the protruding rings 150.7 and 150.8 and the width of the sealing ring 141 is slightly greater than the width of the groove 142 of the clasp 143 and the sum of the thickness of the protruding rings 150.7 and 150.8 and the width of the support ring 140 is slightly smaller than the width of the groove 142 of the clasp 143 such that the protruding rings 150.7 and 150.8 are capable of being received in the groove 142, and the protruding rings 150.7 and 150.8 squeeze the sealing ring 141 such that it deforms and seals the connection between the gas conveying sub-pipelines 104.7 and 104.8 The surface of the side of the protruding rings 150.7 and 150.8 shown in FIG. 3 that is away from the sealing ring 141 is inclined, and for protruding rings with such structure, the thickness of the protruding ring herein refers to the maximum thickness of the portion thereof that enters the groove 142 of the clasp 143. Where there is a need to detach the gas conveying sub-pipelines 104.7 and 104.8, release the lock member 139 on the quick-release clamp 130 and rotate the first and second clamping portions 131, 132 of the quick-release clamp 130 such that the respective first ends 133 and 134 of the first and second clamping portions 131, 132 are away from each other. At this point, the quick-release clamp 130 is opened and the gas conveying sub-pipelines 104.7 and 104.8 are separated and disengaged from the sealing ring 141 on the support ring 140 of the quick-release clamp 130. Although FIG. 3 only shows the structure of two gas conveying sub-pipelines 104.7 and 104.8 connected by the quick-release clamp 130, it should be understood that other adjacent gas conveying sub-pipelines are connected by the quick-release clamp 130 in a similar manner, and adjacent gas discharge sub-pipelines are also connected by the quick-release clamp 130 in a similar manner. In addition, the gas supply tube 111 disposed on the gas conveying sub-pipeline and the gas recovery tube 112 disposed on the gas discharge sub-pipeline are similarly detachably connected to the connecting tube 113 on the furnace chambers Li of the reflow oven 100 by the quick-release clamp 130.

As the gas conveying pipeline 104 and the gas discharge pipeline 106 of the present application are formed by detachably connecting a plurality of gas conveying sub-pipelines 104.i and a plurality of gas discharge sub-pipelines 106.i, respectively, the gas conveying pipeline 104 and gas discharge pipeline 106 of the present application are easy to disassemble for cleaning and maintenance. Moreover, only a portion of the gas conveying sub-pipelines 104.i or the gas discharge sub-pipelines 106.i may be disassembled for cleaning and maintenance. In addition, since the plurality of gas conveying sub-pipelines 104.i and the plurality of gas discharge sub-pipelines 106.i each comprise retractable gas conveying sub-pipelines and a gas discharge sub-pipelines, the distance between the gas supply tube 111 on any two gas conveying sub-pipelines 104.i and the gas recovery tube 112 on any two gas discharge sub-pipelines 106.i does not have to be precisely designed to be consistent with the distance between the connecting tube 113 on the respective two furnace chambers Li. Cumulative mounting error of the plurality of gas conveying sub-pipelines 104.i and the plurality of gas discharge sub-pipelines 106.i can be avoided by using the retractable gas conveying sub-pipelines 104.i and the retractable gas discharge sub-pipelines 106.i; prevent misalignment and failure of connection between the gas supply tube 111 on the gas conveying sub-pipelines 104.i and the gas recovery tube 112 on the gas discharge sub-pipelines 106.i to the connecting tube 113 of the corresponding furnace chamber. In particular, when the distance between the gas supply tube 111 on the two gas conveying sub-pipelines 104.i connected to the connecting tube 113 of the two furnace chambers or the distance between the gas recovery tube 112 on the two gas discharge sub-pipelines 106.i and the distance between the connecting tube 113 of these two furnace chambers are not consistent, the gas supply tube 111 and the gas recovery tube 112 may be aligned to connect to the corresponding connecting tube 113 by adjusting the retractable sub-pipelines.

In the example shown in FIG. 1a, the gas discharge pipeline 106 is a connected gas discharge passage for recovering air from the furnace chambers L1-L17 of the heating zone 102. However, since the gas discharge pipeline 106 of the reflow oven according to the present application is formed by a plurality of gas discharge sub-pipelines 106.i detachably connected in a series, the furnace chambers Li in the heating zone 102 of the reflow oven 100 of the present application may be divided into m furnace chamber segments Q1-Qm and the gas discharge sub-pipelines 106.i may be connected in a series to form m gas discharge pipeline segments Z1-Zm such that the m gas discharge pipeline segments Z1-Zm are used to recover air from the corresponding m furnace chamber segments Q1-Qm. As the plurality of gas discharge sub-pipelines 106.i may be divided into different gas discharge pipeline segments as needed, and different gas discharge pipeline segments may be used to recover air from the corresponding furnace chamber segments, respectively, the design of the gas discharge pipeline of the present application improves the ability to recover air from the furnace chambers.

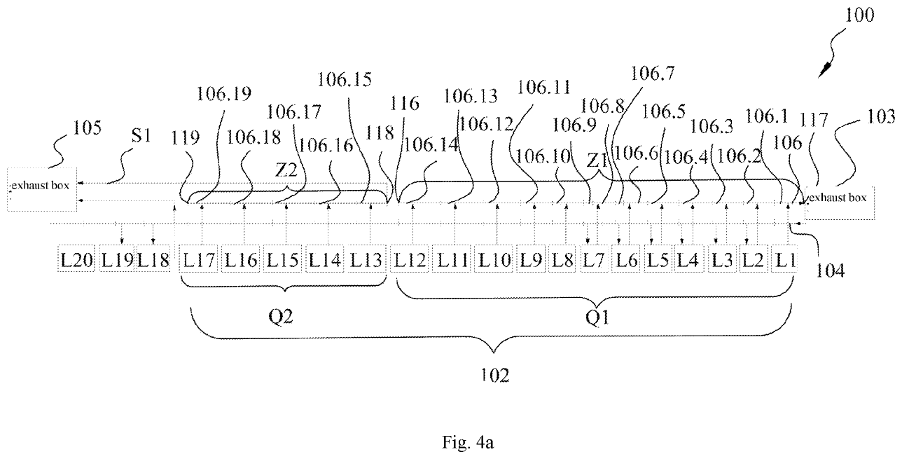

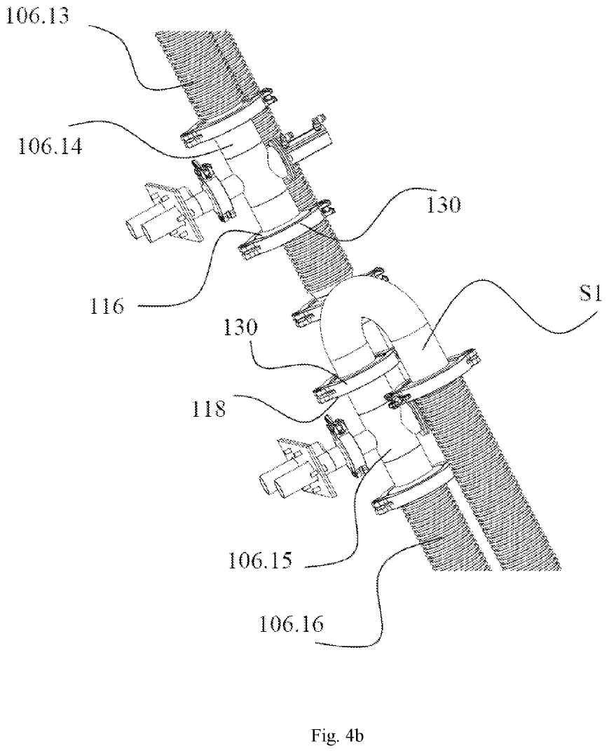

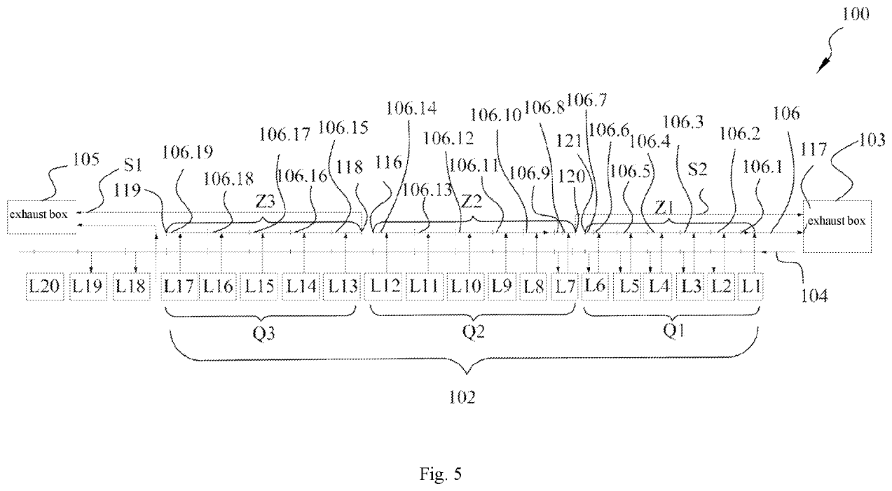

FIGS. 4a-5 exemplarily show an example in which the gas discharge sub-pipelines 106.i are divided into two or three gas discharge pipeline segments to recover air from the corresponding two or three furnace chamber segments.

FIG. 4a shows a schematic view of an alternative disposition for the gas discharge pipeline 106 of the heating zone 102 of the reflow oven 100 according to the present application. In the example shown in FIG. 4a, the furnace chambers L1-L17 of the heating zone 102 is divided into two furnace chamber segments Q1 and Q2. The furnace chamber segment Q1 comprises the furnace chambers L1-L12 and the furnace chamber segment Q2 comprises the furnace chambers L13-L17. The gas discharge sub-pipelines 106.1-106.19 are connected in a series to form two gas discharge pipeline segments Z1 and Z2, the gas discharge pipeline segment ZI comprising the gas discharge sub-pipelines 106.1-106.14 and the gas discharge sub-pipeline segment Z2 comprising the gas discharge sub-pipelines 106.15-106.19. At least a portion of the gas discharge sub-pipelines 106.i in the gas discharge pipeline segment Z1 and at least a portion of the furnace chambers Li in the furnace chamber segment Q1 are connected to recover air from the furnace chamber segment Q1, and at least a portion of the gas discharge sub-pipelines 106.i in the gas discharge pipeline segment Z2 and at least a portion of the furnace chambers Li in the furnace chamber segment Q2 are connected to recover air from the furnace chamber segment Q2. Further as shown in FIG. 4a, an end 116 of the gas discharge sub-pipeline 106.14 of the gas discharge pipeline segment Z1 is closed and an end 117 of the gas discharge sub-pipeline 106.1 is open such that air from the furnace chamber segment Q1 is able to enter the exhaust box 103 via the gas discharge pipeline segment Z1. An end 119 of the gas discharge sub-pipeline 106.19 of the gas discharge pipeline segment Z2 is closed and an end 118 of the gas discharge sub-pipeline 106.15 is open such that air from the furnace chamber segment Q2 is able to enter the exhaust box 105 via the gas discharge pipeline segment Z2. To ensure that air entering the gas discharge pipeline segment Z2 reaches the exhaust box 105, an additional pipeline S1 connected to the exhaust box 105 is connected to the end 118 of the gas discharge sub-pipeline 106.15.

FIG. 4b is an enlarged view of the partial structure of the gas conveying pipeline 104 and the gas discharge pipeline 106 of the reflow oven 100 shown in FIG. 4a, and shows the structure of the gas discharge pipeline segments Z1 and Z2 at separated positions. As shown in FIG. 4b, the additional pipeline S1 is also connected to the end 118 of the gas discharge sub-pipeline 106.15 by the quick-release clamp 130, and the end 116 is closed by connecting the end 116 and a disc (not shown) of the gas discharge sub-pipeline 106.14 through the quick-release clamp 130. Further as shown in FIG. 4b, a portion of the gas discharge sub-pipeline 106.13 of the gas discharge pipeline segment Z1 is a corrugated steel tube, and a portion of the gas discharge sub-pipeline 106.16 of the gas discharge pipeline segment Z2 is also a corrugated steel tube. Although not shown in FIG. 4b, a portion of other gas discharge sub-pipelines 106.i of the gas discharge pipeline segment Z1 or the gas discharge pipeline segment Z2 may also comprise corrugated steel tubes.

FIG. 5 shows a schematic view of another alternative disposition for the gas discharge pipeline 106 of the heating zone 102 of the reflow oven 100 according to the present application. In the example shown in FIG. 5, the furnace chambers L1-L17 of the heating zone 102 is divided into three furnace chamber segments Q1, Q2, and Q3. The furnace chamber segment Q1 comprises the furnace chambers L1-L6, the furnace chamber segment Q2 comprises the furnace chambers L7-L12, and the furnace chamber segment Q3 comprises the furnace chambers L13-L17. The gas discharge sub-pipelines 106.1-106.19 are connected in a series to form three gas discharge pipeline segments Z1, Z2 and Z3, the gas discharge pipeline segment Z1 comprising the gas discharge sub-pipelines 106.1-106.7, the gas discharge pipeline segment Z2 comprising the gas discharge sub-pipelines 106.8 106.14, and the gas discharge pipeline segment Z3 comprising the gas discharge sub-pipelines 106.15-106.19. At least a portion of the gas discharge sub-pipelines 106.i of the gas discharge pipeline segment Z1 and at least a portion of the furnace chambers Li in the furnace chamber segment Q1 are connected to recover air from the furnace chamber segment Q1, at least a portion of the gas discharge sub-pipelines 106.i of the gas discharge pipeline segment Z2 and at least a portion of the furnace chambers Li of the furnace chamber segment Q2 are connected to recover air from the furnace chamber segment Q2, and at least a portion of the gas discharge sub-pipelines 106.i of the gas discharge pipeline segment Z3 and at least a portion of the furnace chambers Li of the furnace chamber segment Q3 are connected to recover air from the furnace chamber segment Q3. Further as shown in FIG. 5, an end 121 of the gas discharge sub-pipeline 106.7 of the gas discharge pipeline segment Z1 is closed and the end 117 of the gas discharge sub-pipeline 106.1 is open such that air from the furnace chamber segment Q1 is able to enter the exhaust box 103 through the gas discharge pipeline segment Z1. The end 116 of the gas discharge sub-pipeline 106.14 of the gas discharge pipeline segment Z2 is closed and an end 120 of the gas discharge sub-pipeline 106.8 is open such that air from the furnace chamber segment Q2 is able to enter the exhaust box 103 via the gas discharge pipeline segment Z2. The end 119 of the gas discharge sub-pipeline 106.19 of the gas discharge pipeline segment Z3 is closed and the end 118 of the gas discharge sub-pipeline 106.15 is open such that air from the furnace chamber segment Q3 is able to enter the exhaust box 105 via the gas discharge pipeline segment Z3. To ensure that air entering the gas discharge pipeline segment Z2 reaches the exhaust box 103, an additional pipeline S2 connected to the exhaust box 103 is connected to the end 120 of the gas discharge sub-pipeline 106.8. To ensure that air entering the gas discharge pipeline segment Z3 reaches the exhaust box 105, an additional pipeline S1 connected to the exhaust box 105 is connected to the end 118 of the gas discharge sub-pipeline 106.15.

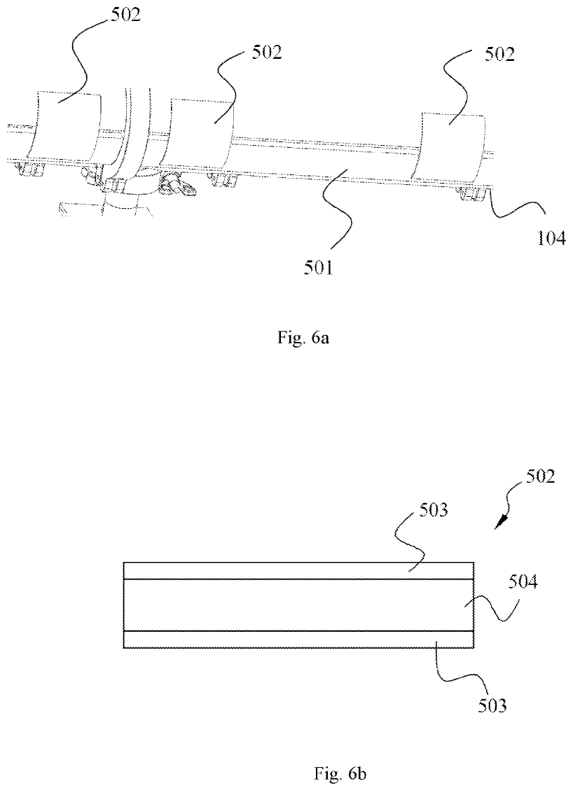

An insulating sleeve 501 wraps the outside of the gas conveying pipeline 104 and the gas discharge pipeline 106 of the reflow oven according to the present application. FIG. 6a shows a partial enlarged view of the gas conveying pipeline 104 wrapped with the insulating sleeve 501. The insulating sleeve 501 has a rectangular expanded shape and is disposed with a plurality of hook-and-loop fasteners 502 on opposite ends in the length direction thereof. When the insulating sleeve 501 wraps the outside of the gas conveying pipeline 104, it connects the opposite ends of the insulating sleeve 501 in the length direction through the plurality of hook-and-loop fasteners 502 such that the insulating sleeve wraps the outside of the gas conveying pipeline 104. The hook-and-loop fastener 502 connection is easy to release, allowing for convenient detachment of the insulating sleeve 501, which in turn allows for disassembly of the gas conveying pipeline 104 and the gas discharge pipeline 106 for maintenance or cleaning. Moreover, the hook-and-loop fasteners 502 may be repeatedly attached such that the insulating sleeve 501 may be used again to wrap the gas conveying pipeline 104 and the gas discharge pipeline 106 after detachment. FIG. 6b shows a cross-sectional view of the insulating sleeve 501 in the expanded state. As shown in FIG. 6b, the insulating tube 501 comprises a layer of insulating material 504 and a layer of fibrous material 503 attached to both sides thereof. In an example, the layer of insulating material 504 is made of mineral wool, where the fibrous material 503 is attached to both sides thereof to facilitate connecting the hook-and-loop fasteners 502 to the insulating sleeve 501. Although opposite ends of the insulating sleeve 501 are shown to be connected using hook-and-loop fasteners in FIG. 6a, other connection structures may be used such that both ends of the insulating sleeve 501 are detachably connected in other examples.

Summing up the above description, the present application has at least the following technical effects:
1. As the gas conveying pipeline and the gas discharge pipeline are connected by a plurality of gas conveying sub-pipelines and gas discharge sub-pipelines, respectively, the gas conveying pipeline and gas discharge pipeline are easy to disassemble for cleaning or maintenance.
2. The dimensions of the gas conveying sub-pipelines and gas discharge sub-pipelines do not have to be designed very precisely and the connection of the gas conveying sub-pipelines and the gas discharge sub-pipelines to the connecting tubes on the furnace chamber is not affected by mounting errors as retractable gas conveying sub-pipelines and gas discharge sub-pipeline are used.
3. As the gas discharge pipeline is formed by connecting a plurality of gas discharge sub-pipelines, it may be divided into gas discharge pipeline segments as needed to be used for gas recovery from the corresponding furnace chamber segment, thereby increasing recovery capabilities.
4. The use of an easy-to-detach and reusable connection structure makes it easy to detach the insulating sleeve and allows the insulating sleeve to be reused by wrapping the gas conveying pipeline and gas discharge pipeline again after detachment.

Although the present disclosure has been described in conjunction with the examples outlined above, various alternatives, modifications, variations, improvements, and/or substantial equivalents, whether known or foreseeable now or in the near future, may be apparent to those having at least ordinary skill in the art. In addition, the technical effects and/or technical problems described in the present specification are exemplary and not limiting; therefore, the disclosure in the present specification may be used to solve other technical problems and have other technical effects and/or may solve other technical problems. Therefore, the examples of the present disclosure as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

1. A reflow oven, comprising:
a furnace, comprising a plurality of furnace chambers Li; and
a gas pipeline assembly, comprising a plurality of gas sub-pipelines,
wherein the plurality of gas sub-pipelines may be detachably connected in a series to form a gas passage, and
wherein at least a portion of the plurality of gas sub-pipelines is connected to at least a portion of the plurality of furnace chambers Li such that the plurality of furnace chambers Li is connected to the gas passage.

2. The reflow oven according to claim 1, wherein
the gas pipeline assembly comprises a gas discharge pipeline;
in which, the gas discharge pipeline comprises a plurality of gas discharge sub-pipelines that are detachably connected in a series to form a gas discharge passage, at least a portion of the plurality of gas discharge sub-pipelines being connected to at least a portion of the plurality of furnace chambers Li to recover gas from the plurality of furnace chambers Li.

3. The reflow oven according to claim 2, wherein the gas pipeline assembly comprises a gas conveying pipeline, the gas conveying pipeline comprising a plurality of gas conveying sub-pipelines that are detachably connected in a series to form a gas conveying passage, at least a portion of the plurality of gas conveying sub-pipelines being connected to at least a portion of the plurality of furnace chambers Li to convey gas to the plurality of furnace chambers Li.

4. The gas pipeline according to claim 3, wherein the plurality of gas discharge sub-pipelines and the plurality of gas conveying sub-pipelines each comprise at least one retractable tube.

5. The reflow oven according to claim 4, wherein the retractable tube is a corrugated steel tube.

6. The reflow oven according to claim 3, wherein the reflow oven further comprises a plurality of quick-release components, the adjacent plurality of gas discharge sub-pipelines and the adjacent plurality of gas conveying sub-pipelines being detachably connected through the plurality of quick-release components, respectively.

7. The reflow oven according to claim 6, wherein the quick-release component is a quick-release clamp, and each quick-release clamp comprises:
a first clamping portion and a second clamping portion, the first and second clamping portions each have a receiving opening at a respective first end, and the first and second clamping portions are rotatably connected at a respective second end such that the respective first ends of the first and second clamping portions are movable towards or away from one another, and when the respective first ends of the first and second clamping portions are connected to each other, the quick-release clamp is in the locked position and forms a clasp, in which, a groove extending along the inner surface of the clasp is provided thereon;
a support ring, which has a width that is smaller than the groove of the clasp and when the quick-release clamp is in the locked position, the support ring is positioned on the inner side of the clasp;
a sealing ring, where the width of the sealing ring is between the width of the groove of the clasp and the width of the support ring, and when the quick-release clamp is in the locked position, the sealing ring is positioned between the support ring and the clasp; and
a lock member, which may be inserted into and secured in the receiving opening of the first and second clamping portions, when the lock member is inserted into and secured in the receiving openings, the first and second clamping portions are connected together, and when the lock member is removed from the receiving openings, the first and second clamping portions are rotatable such that respective first ends are away from each other to release the connection between the quick-release clamp and the adjacent gas discharge sub-pipelines or adjacent gas conveying sub-pipelines; and
wherein the plurality of gas discharge sub-pipelines and the plurality of gas conveying sub-pipelines comprise protruding rings disposed at both ends of the plurality of gas discharge sub-pipelines and the plurality of gas conveying sub-pipelines, when the quick-release clamp connects two adjacent gas discharge sub-pipelines in the plurality of gas discharge sub-pipelines or two adjacent gas conveying sub-pipelines in the plurality of gas conveying sub-pipelines, two adjacent protruding rings of the plurality of two adjacent gas discharge sub-pipelines or two adjacent conveying sub-pipelines are received and secured in the groove of the clasp, and the two adjacent protruding rings engage both sides of the sealing ring in the width direction, respectively.

8. The reflow oven according to claim 7, wherein
the sum of the thickness of the two adjacent protruding rings and the width of the sealing ring is slightly greater than the width of the groove of the clasp such that when the two adjacent protruding rings are received and secured in the groove of the clasp, the two adjacent protruding rings squeeze the sealing ring such that the sealing ring deforms and seals the connection between the two adjacent gas discharge sub-pipelines or the two adjacent gas conveying sub-pipelines; and
the sum of the thickness of the two adjacent protruding rings and the width of the support ring is slightly smaller than the width of the groove of the clasp such that the two adjacent protruding rings are capable of being received by the groove of the clasp.

9. The reflow oven according to claim 8, wherein the protruding rings have a step at a position proximate to the bottom such that when the quick-release clamp is in the locked position, the step of the protruding rings is supported on the support ring.

10. The reflow oven according to claim 6, wherein the at least a portion of the plurality of gas discharge sub-pipelines is connected to a gas recovery tube and the at least a portion of the plurality of gas conveying sub-pipelines is connected to a gas supply tube; and
the reflow oven further comprises a plurality of connecting tubes connecting to at least a portion of the plurality of furnace areas Li,
wherein the gas recovery tube and the gas supply tube are detachably connected by a respective connecting tube on the quick-release clamp and corresponding furnace chambers Li, respectively.

11. The reflow oven according to claim 1, wherein the reflow oven further comprises an insulating sleeve that detachably wraps the outside of the gas pipeline assembly, the insulating sleeve comprising:
a layer of insulating material and a layer of fibrous material attached to both sides thereof; and
a connecting structure, connected to the layer of fibrous material, when the insulating sleeve wraps the outside of gas pipeline assembly, the connecting structure causes both ends of the insulating sleeve to be detachably connected, so as to wrap the gas pipeline assembly.

12. The reflow oven according to claim 11, wherein
the layer of insulating material is made of mineral wool, and the connecting structure is a hook-and-loop fastener.

13. A reflow oven, comprising
a heating zone, which comprises a plurality of furnace chambers Li divided into at least two segments, which comprise a furnace chamber segment Q1 and a furnace chamber segment Q2;
a gas discharge pipeline, which comprises a plurality of gas discharge sub-pipelines detachably connected in a series to at least two gas discharge pipeline segments, which comprise a first gas discharge pipeline segment Z1 and a second gas discharge pipeline segment Z2; and
in which, a first number of gas discharge sub-pipelines in the plurality of gas discharge sub-pipelines is detachably connected in a series to form the first gas discharge pipeline segment Z1, which is connected to the furnace chamber segment Q1 and recovers gas therefrom;
in which, a second number of gas discharge sub-pipelines in the plurality of gas discharge sub-pipelines is detachably connected in a series to form the second gas discharge pipeline segment Z2, which is connected to the furnace chamber segment Q2 and recovers gas therefrom.

14. The reflow oven according to claim 13, wherein
the plurality of furnace chambers Li is divided into m furnace chamber segments, which comprise the furnace chamber segment Q1, furnace chamber segment Q2,. furnace chamber segment Qm;
the plurality of gas discharge sub-pipelines is divided into m segments, and the plurality of gas discharge sub-pipelines is detachably connected in a series to form m gas discharge pipeline segments, which comprise the first gas discharge pipeline segment Z1, second gas discharge pipeline segment Z2 . . . , m gas discharge pipeline segment Zm;
in which, the m gas discharge pipeline segments are connected to the corresponding m furnace chamber segments, respectively, to recover gas from the m furnace chamber segments, respectively.

15. The reflow oven ccording to claim 14, wherein at least a portion of the m gas discharge pipeline segments comprise at least one retractable tube.

16. The reflow oven according to claim 13, wherein the adjacent plurality of gas discharge sub-pipelines is connected through quick-release clamps.
